(19) United States
(12) Patent Application Publication
(10) Pub. No.: US 2018/0373343 A1
(43) Pub. Date: Dec. 27, 2018

(54) VEHICLE OPERATION DEVICE

(71) Applicant: HONDA MOTOR CO., LTD., Tokyo (JP)

(72) Inventors: Masayuki HASHIMOTO, Wako-shi (JP); Tomoyuki SAKURAI, Wako-shi (JP); Koji AOKI, Wako-shi (JP)

(21) Appl. No.: 16/017,045

(22) Filed: Jun. 25, 2018

(30) Foreign Application Priority Data
Jun. 26, 2017 (JP) 2017-124537

(51) Int. Cl. G06F 3/02; B60W 50/14; B60W 30/06

(52) U.S. Cl. CPC G06F 3/02; B60W 50/14; B60W 2050/0074; B60W 2050/146; B60W 30/06

(57) ABSTRACT

A vehicle operation device (13) for enabling a vehicle operator to operate a vehicle (1), includes a switch unit (17) provided at a side of a vehicle operator's seat (21), and configured to accept an input operation for automatic drive of the vehicle. A first switch included in the switch unit (42) and configured to produce a signal relating to a control action for vehicle travel is provided with an inadvertent operation prevention feature configured to prevent an unintended contact to the first switch.

### TECHNICAL FIELD

The present invention relates to a vehicle operation device for enabling a vehicle operator to operate a vehicle.

### BACKGROUND ART

Various forms of automatic drive of a vehicle are known in the art. JP2011-131715A discloses a parking assist system for providing an assistance when parking a vehicle. According to this prior art, a parking assist control is initiated when a parallel parking switch or a perpendicular parking switch provided on the dashboard of the vehicle is operated by the vehicle operator.

However, because the dashboard is crowded with various switches for operating an air conditioner, starting the engine, activating defroster, lights and windshield wipers, and selecting driving modes, the vehicle operator may find some difficulty in promptly and correctly identifying the switches for initiating automatic drive of the vehicle. Also, the steering wheel may turn by itself during automatic drive of the vehicle such as when automatic parking operation is being performed. Therefore, if the vehicle operator reaches for a switch on the dashboard for initiating or otherwise controlling the automatic drive of the vehicle, the vehicle operator's hand may inadvertently touch the steering wheel. As a result, the automatic parking operation is interrupted against the will of the vehicle operator. To avoid such a situation, the vehicle operator is required to operate the switches while heeding not to touch the steering wheel. By noting such a problem of the prior art, the inventors of this application have come to realize that the dashboard may not be a suitable place for placing switches associated with automatic drive of the vehicle.

### SUMMARY OF THE INVENTION

In view of such a problem of the prior art, a primary object of the present invention is to provide a vehicle operation device for enabling a vehicle operator to operate an automatic drive vehicle in a comfortable manner.

### Means for Accomplishing the Task

To achieve such an object, one aspect of the present invention provides a vehicle operation device (13) for enabling a vehicle operator to operate a vehicle (1), comprising: a switch unit (17) provided at a side of a vehicle operator's seat (21), and configured to accept an input operation for automatic drive of the vehicle.

Since the switch unit for accepting the input operation for automatic drive is provided at a side of the vehicle operator's seat separately or independently from other switches and input devices, the vehicle operator is enabled to identify the switch unit easily, and operate the switch unit in a comfortable manner. The vehicle operator can operate the switch unit using simply by moving his or her arm so that the operation can be performed in an effortless manner. Also, the steering wheel will not be in the way of operating the switching unit.

Preferably, the switch unit is positioned next to a side of a seat cushion (24) of the vehicle operator's seat.

Thereby, the vehicle operator can operate the switch unit simply lowering his or her arm while seated in the seat so that the operation is both comfortable and easy.

Preferably, the switch unit includes a first switch (42) provided with an inadvertent operation prevention feature configured to prevent an unintended contact to the first switch.

Thereby, an inadvertent operation of the switch unit can be avoided. In particular, even when the vehicle operating is getting on or off the vehicle, the vehicle operator is prevented from inadvertently touching or operating the first switch unit.

Preferably, the first switch is configured to produce a signal relating to a control action for vehicle travel.

In such a case, it is particularly important to prevent inadvertent operation of the switch unit, and the inadvertent operation prevention feature is very effective in ensuring a high level of vehicle safety.

Preferably, the first switch comprises a momentary switch that enables automatic drive of the vehicle only while being operated.

Because the automatic drive is permitted only during the time the vehicle operator is intentionally operating the first switch unit, a high level of vehicle safety can be ensured.

Preferably, the first switch comprises a knob (49) that turns on the first switch when pulled up as the inadvertent operation prevention feature.

Thereby, the first switch is prevented from being turned on simply by an accidental contact so that a high level of safety can be ensured.

Preferably, the first switch is disposed rearward of a center of the seat cushion with respect to a fore and aft direction.

Thereby, the chance of the vehicle operator unintentionally touching the first switch as the vehicle get on and off the vehicle can be minimized.

Preferably, the switch unit is disposed adjacent to a side of the seat cushion facing a door opening.

Thereby, the switch unit can be conveniently positioned in a space created between the door opening and the seat cushion.

The switch unit may be positioned on a floor of the vehicle.

Thereby, a part of the floor located between the seat cushion and the door opening can be conveniently used for accommodating the switch unit.

Preferably, an operation surface (36) of the switch unit is disposed below a seating surface of the seat cushion.

Thereby, the vehicle operator is prevented from touching the switch unit as the vehicle operator gets on and off the vehicle in an even more effective manner.

Preferably, the switch unit includes a second switch (43) consisting of a push button switch configured to produce a signal not relating to a control action for vehicle travel.

By thus configuring the second switch for operations not relating to a control action for vehicle travel to be easy to operate, the convenience in the operation of the switch unit as a whole can be improved.

Preferably, the switch unit is configured to produce a signal for controlling automatic parking of the vehicle.

Thereby, even when the steering wheel is rotating in the automatic parking operation of the vehicle, the vehicle operator is enabled to operate the switch unit without hindering the rotation of the steering wheel or without being hindered by the rotation of the steering wheel.

Preferably, the switch unit is incorporated with an entirety of input devices for controlling automatic drive of the vehicle.

Thereby, the vehicle operator is enabled to control the automatic drive of the vehicle entirely from the switch unit.

The vehicle operation device may further comprise a display device (18) disposed in front of the vehicle operator's seat of the vehicle to display options relating to automatic drive of the vehicle that can be selected by operation of the switch unit.

Thereby, the vehicle operator can control the automatic drive of the vehicle by selecting the various options displayed on the display unit so that the switch unit can be operated without any difficulty. Since the display unit is positioned right in front of the vehicle operator, the vehicle operator can readily comprehend what is shown in the display unit.

Preferably, the display device is configured to display information on an environment surrounding the vehicle associated with a traveling direction of the vehicle.

Thereby, the display device can show the surrounding environment corresponding to the traveling direction of the vehicle without requiring the vehicle operator to select the view of the surrounding environment.

The display device may be configured to display information on an environment surrounding the vehicle in response to an operation of the switch unit.

The display device shows the surrounding environment as desired by the vehicle operator so that the vehicle operator is enabled to control the automatic drive in a comfortable manner.

The vehicle operation device may further comprise an operation terminal (150) that can be transported from the vehicle, and is configured to accept an input operation by the vehicle operator for automatic drive of the vehicle.

The operation terminal allows the vehicle operator to control the automatic drive of the vehicle from outside of the vehicle.

Preferably, the operation terminal includes a display unit configured to display information on an environment surrounding the vehicle associated with a traveling direction of the vehicle.

Thereby, the display device can show the surrounding environment corresponding to the traveling direction of the vehicle without requiring the vehicle operator to select the view of the surrounding environment.

Preferably, the operation terminal includes a display unit (151) configured to display options relating to automatic drive of the vehicle that can be selected by operation of the operation terminal.

The display unit shows the surrounding environment as desired by the vehicle operator so that the vehicle operator is enabled to control the automatic drive in a comfortable manner.

The vehicle operation device according to the present invention thus enables a vehicle operator to operate an automatic drive vehicle in a comfortable manner.

### BRIEF DESCRIPTION OF THE DRAWING(S)

FIG. 1 is a diagram showing a functional structure of a vehicle incorporated with an embodiment of the present invention;

FIG. 2 is a perspective view of a passenger compartment of the vehicle;

FIG. 3 is a front view of a front part of the passenger compartment;

FIG. 4 is a plan view of a vehicle operator's seat and a switch unit provided next to the seat;

FIG. 5 is a display view of a display device in a normal operation;

FIG. 6 is a display view of the display device in automatic drive;

FIG. 7 is a display view of an automatic drive window showing parking options;

FIG. 8 is a display view of the automatic drive window showing a parking space search screen;

FIG. 9 is a display view of the automatic drive window showing an automatic drive screen;

FIG. 10 is a display view of the automatic drive window showing unparking options;

FIG. 11a is a diagram showing a parking process in an automatic parking operation; and

FIG. 11b is a diagram showing an unparking process in an automatic unparking operation.

### DESCRIPTION OF THE PREFERRED EMBODIMENT(S)

A preferred embodiment of the present invention is described in the following with reference to the appended drawings.

### Overall Configuration of Vehicle

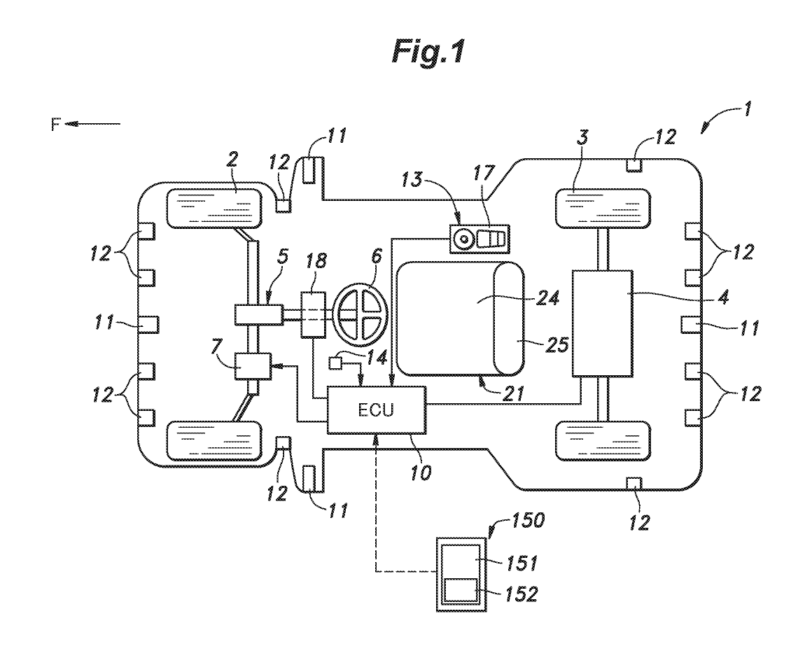

Referring to FIG. 1, the vehicle 1 consists of a small electric vehicle (provided with an internal combustion engine for charging an onboard battery which normally powers the vehicle 1), and includes a pair of front wheels 2, a pair of rear wheels 3, a traveling motor 4 for driving the rear wheels 3, and a steering device 5 for steering the front wheels 2. The steering device 5 may be either a mechanical steering mechanism that mechanically connects the steering wheel 6 with the front wheel 2 or a steer-by-wire steering system that does not mechanically connect the steering wheel 6 with the front wheels 2. In either case, the steering device 5 is a provided with a steering motor 7 for generating a driving force required for changing the steering angle of the front wheels 2, and is configured to change the steering angle of the front wheel 2 in dependence on the rotational angle of the steering wheel 6.

The vehicle 1 is provided with a control device 10 for driving the traveling motor 4 and the steering motor 7 by automatic drive control. The control device 10 is also connected to a camera 11, a sonar 12, an automatic drive operation device 13 (a vehicle operation device), and a shift switch 14 provided in the vehicle 1. The control device 10 may consist of an electronic control device (ECU) including a CPU, memory, an interface, and the like.

The camera 11 may consist of an image capturing device for capturing the image of the environment surrounding of the vehicle 1, and forwards the captured image to the control device 10. In the present embodiment, the camera 11 includes four imaging units configured to capture the image of the environment from all directions of the vehicle 1.

The sonar 12 consists of an acoustic sensor for detecting objects around the vehicle 1, and forwards a signal corresponding to the distances to the detected objects to the control device 10. In the present embodiment, the sonar 12 includes a plurality of sonar modules so as to be able to detect objects from all around the vehicle 1.

The automatic drive operation device 13 consists of an operation input device for a vehicle operator to perform automatic drive control, and includes a switch unit 17 for accepting an input operation for automatic drive of the vehicle 1 by a vehicle operator, and a display device 18 including an LCD panel. The switch unit 17 forwards an operation signal corresponding to each operation input entered by the vehicle operator to the control device 10. The display device 18 is controlled by the control device 10, and displays image information.

The shift switch 14 consists of a switch for the vehicle operator to select the driving mode and the traveling direction of the vehicle 1, and includes drive positions including neutral (N), forward drive (D) and reverse (R). The shift switch 14 forwards a signal indicating the selected drive position to the control device 10.

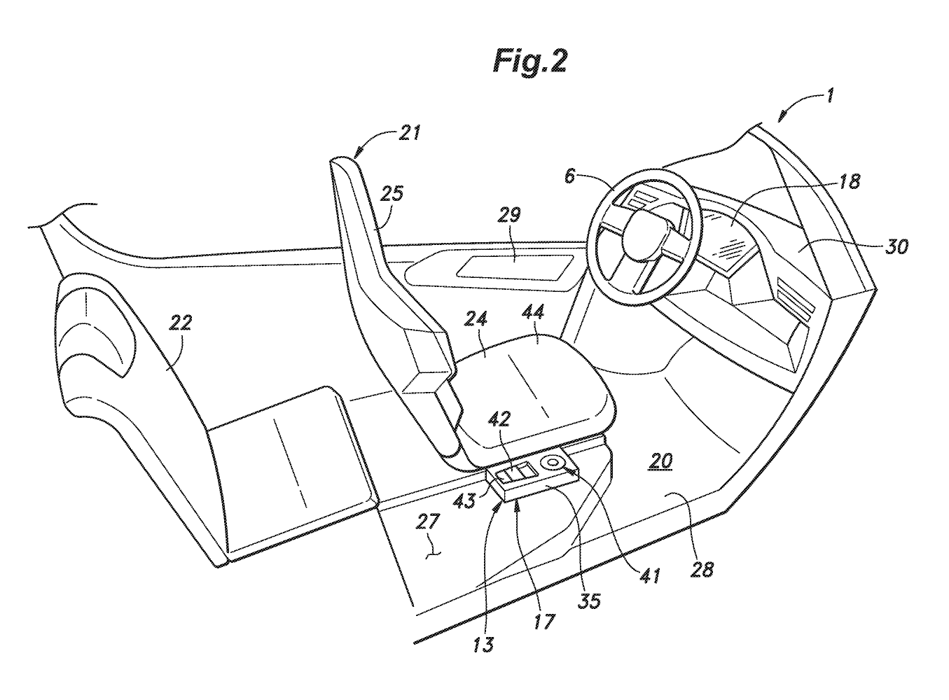

As shown in FIG. 2, the passenger compartment 20 of the vehicle 1 is provided with a front seat or a vehicle operator's seat 21 and a rear seat 22. The vehicle operator's seat 21 is disposed at a laterally central part of the vehicle body, and the rear seat 22 is disposed behind the vehicle operator's seat 21. The vehicle operator's seat 21 is provided with a seat cushion 24 (seat portion) for supporting the vehicle operator from below, and a seat back 25 (back portion) for supporting the back of the vehicle operator. The seat cushion 24 is provided with a rectangular shape in a plan view, and supported on the upper surface of a floor 27 constituting the bottom portion of the passenger compartment 20. The seat back 25 extends upward from the rear end of the seat cushion 24. The vehicle 1 has a pair of door openings 28 on either side of the vehicle operator's seat 21. Each door opening 28 is fitted with a door 29.

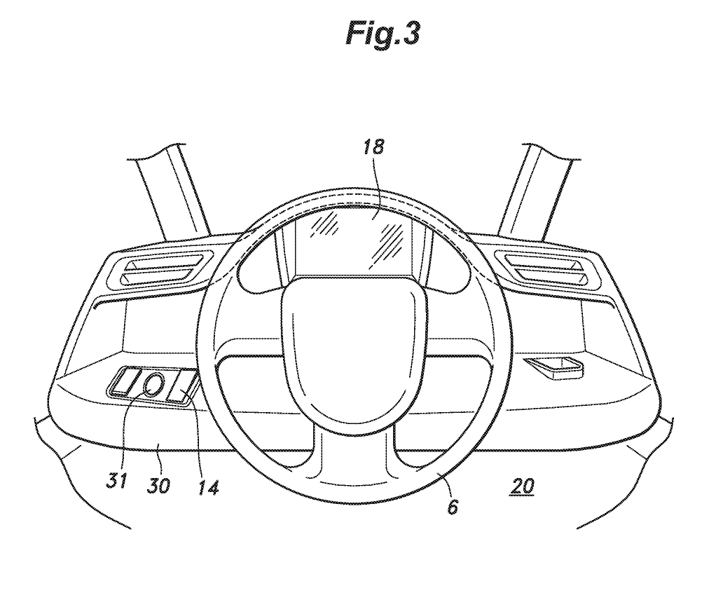

As shown in FIGS. 2 and 3, the steering wheel 6 is provided at the center of a dashboard 30 provided in the front part of the passenger compartment 20. The steering wheel 6 projects rearward from the dashboard 30, and is disposed in front of the vehicle operator's seat 21.

A display device 18 is provided in a part of the dashboard 30 located above the steering wheel 6 and centrally with respect to the lateral direction. The display device 18 is disposed so as to be visible from the vehicle operator seated in the vehicle operator's seat 21 via the inner opening of the steering wheel 6 or above the upper edge of the steering wheel 6.

As shown in FIG. 3, the dashboard 30 is provided with a shift switch 14, a hazard switch 31, a power switch (not shown), and the like.

### Switch Unit

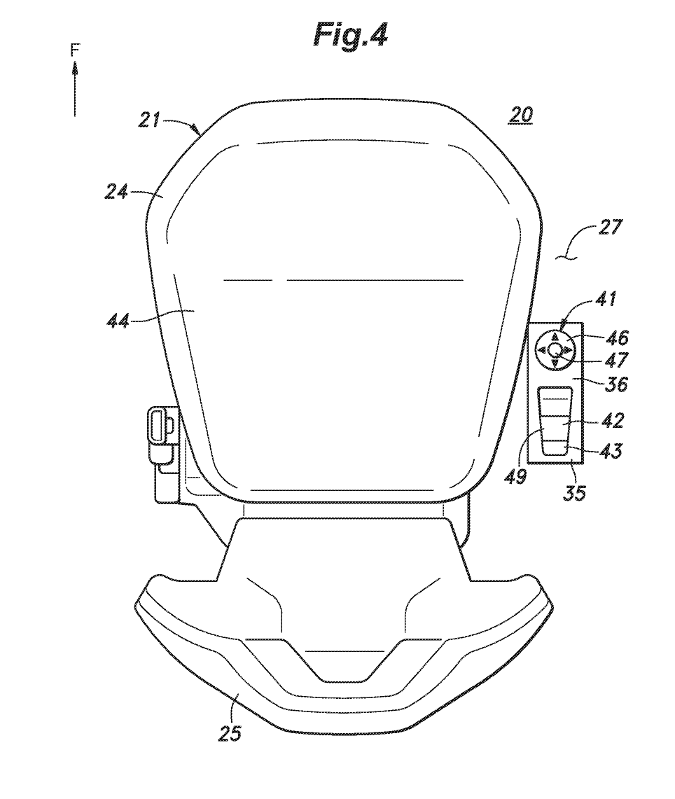

As shown in FIGS. 2 and 4, the switch unit 17 is provided on a right side of the seat cushion 24 of the vehicle operator's seat 21 or, in particular, next to a side of the seat cushion 24. The switch unit 17 is provided with a switch case 35 consisting of a box elongated in the fore and aft direction, and is fixedly attached to the upper surface of the floor 27. The switch case 35 is provided between the side portion of the seat cushion 24 and the door opening 28 in plan view. Since the vehicle operator's seat 21 is disposed at the center of the passenger compartment 20 with respect to the width direction of the vehicle, the distance between the side portion of the seat cushion 24 and the door opening 28 may be greater than when there are two seats next to each other as is the case with more conventional vehicles. Therefore, the space for arranging the switch unit 17 on the upper surface of the floor 27 is particularly amply available. Further, the switch case 35 is disposed next to a rear part of the seat cushion 24. This is advantageous because the rear part of the seat cushion 24 is typically narrower than the front part of the seat cushion 24, and also because the vehicle operator is less likely to interfere with the switch unit 17 as compared to a more front part of the seat cushion 24.

The upper surface of the switch case 35 forms an operation surface 36 which is provided with a selection switch 41, an automatic drive continuation switch 42 (first switch), and an automatic drive on/off switch 43 (second switch). The operation surface 36 is disposed below a seat surface 44 defining the upper surface of the seat cushion 24. On the operation surface 36, the selection switch 41, the automatic drive continuation switch 42, and the automatic drive on/off switch 43 are arranged in this order from the front side. The automatic drive continuation switch 42 is disposed rearward of the center of the seat cushion 24 with respect to the fore and aft direction.

The selection switch 41 includes a direction button 46 which is formed in a ring shape by being partitioned into four regions in the circumferential direction, or an upper, a right, a lower, and a left region, and a determination button 47 which is positioned in the center of the four regions of the direction button 46. The direction button 46 consists of a tiltable push button type momentary switch (push return), and outputs a signal corresponding to the up, down, right, or left region that is pressed. The determination button 47 also consists of a push button type momentary switch.

The automatic drive on/off switch 43 also consists of a push button type momentary switch. It is preferable that the upper surface of the automatic drive on/off switch 43 is disposed on the same plane as the operation surface 36 (or flush with the operation surface 36) when not operated, and is disposed below the operation surface 36 when operated.

The automatic drive continuation switch 42 consists of a pull-up type switch provided with a knob 49 that operates automatic drive continuation switch 42 when pulled up so as to prevent an inadvertent operation of the automatic drive continuation switch 42. The knob 49 is pivotally supported in the rear part thereof by the switch case 35 via a pivot shaft extending in the lateral direction. The automatic drive continuation switch 42 is a momentary switch (pull return). It is preferable that the upper surface of the knob 49 of the automatic drive continuation switch 42 is disposed on the same plane as the operation surface 36 (or flush with the operation surface 36) when not operated and protrudes above the operation surface 36 when operated.

### Automatic Drive Control

The control device 10 is configured to perform an automatic drive control including an automatic parking control for moving the vehicle 1 from a road to a parking space, and an automatic unparking control for moving the vehicle 1 from the parking space to the road. The control device 10 executes and stops the automatic drive control according to a signal from the automatic drive on/off switch 43. When the vehicle operator presses the automatic drive on/off switch 43, the control device 10 starts the automatic drive control according to the signal from the automatic drive on/off switch 43. Thereafter, when the vehicle operator pushes the automatic drive on/off switch 43 again during the execution of the automatic drive control, and the control device 10 receives the corresponding signal from the automatic drive on/off switch 43, the control device 10 stops the automatic drive control.

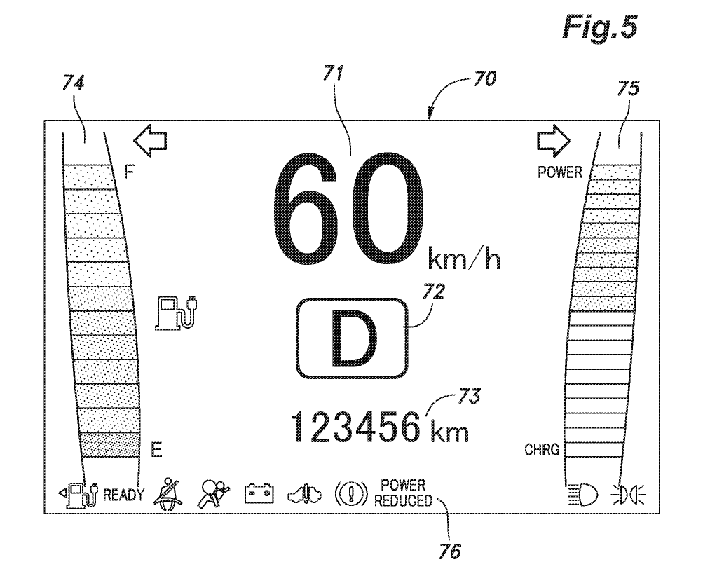

The control device 10 displays an image display 70 (or screen) on the display device 18, and changes the content of the image display 70 between the automatic drive control and the normal operation control. As shown in FIG. 5, during the normal operation control, a traveling speed indication 71 indicating the traveling speed, a shift position indication 72 indicating the selected shift position, and an odometer information indication 73 indicating the distance traveled by the vehicle 1 are arranged in the center of the screen of the display device 18. A fuel level indication 74 showing information on the remaining fuel level is arranged on the left edge of the screen, and a battery status indication 75 showing information on the state of charge of the battery is arranged on the right edge of the screen. A status display 76 including an indication relating to the state of the head lights, a seat belt warning light, a brake warning light, an air bag warning light, and a fuel level warning light are arranged on the lower edge of the screen.

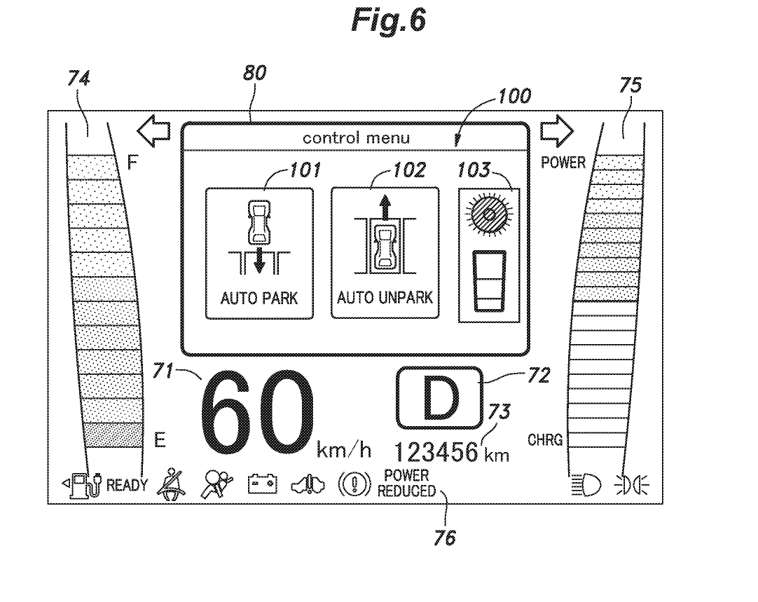

As shown in FIG. 6, during the automatic drive control, an automatic drive window 80 is displayed in the center of the image display 70, and the traveling speed indication 71, the shift position indication 72 and the odometer information indication 73 are displayed under the automatic drive window 80 in a smaller size than during the normal operation (non-automatic drive). The fuel level indication 74, the battery status indication 75, and the status display 76 are arranged at the same position during the automatic drive control and the normal operation control.

### Automatic Parking Control

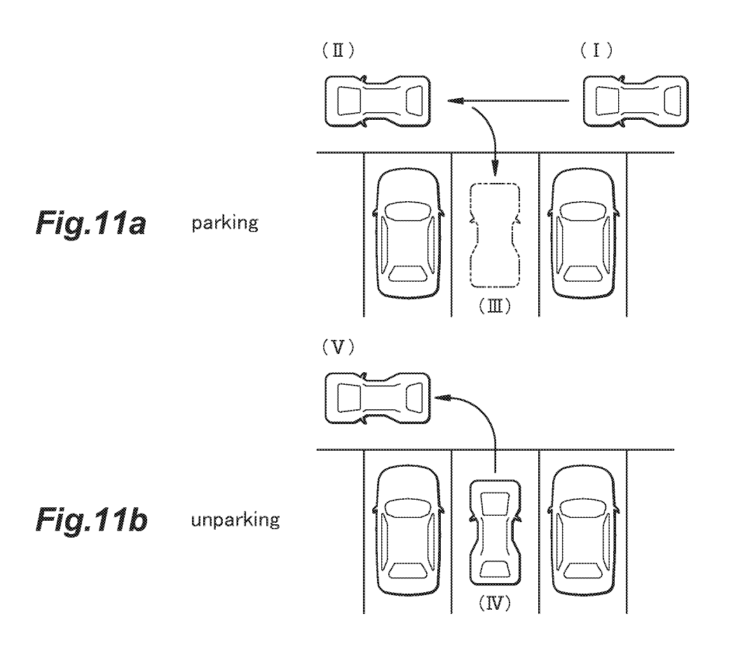

When initiating the automatic parking control, the vehicle operator stops the vehicle 1 besides a parking space selected by the vehicle operator (see (I) in FIG. 11), and presses the automatic drive on/off switch 43. As a result, the control device 10 starts the automatic drive control, and the automatic drive window 80 is displayed in the center of the display device 18. In the automatic drive window 80, initially, a parking/unparking selection screen 100 is displayed as shown in FIG. 6. The parking/unparking selection screen 100 shows an automatic parking icon 101 corresponding to the automatic parking control and an automatic unparking icon 102 corresponding to the automatic unparking control. When one of the icons 101 and 102 is selected, the selected icon is displayed more brightly than the other icon, or is surrounded by a frame, so that the vehicle operator can identify the selected icon. The parking/unparking selection screen 100 further shows a guidance display 103 using text and/or graphics. For example, a graphic representing the switch unit 17 to be operated may be displayed. For instance, the vehicle operator selects the automatic parking icon 101 by operating the direction button 46 of the selection switch 41, and presses the determination button 47, thereby completing the selection of the automatic parking control.

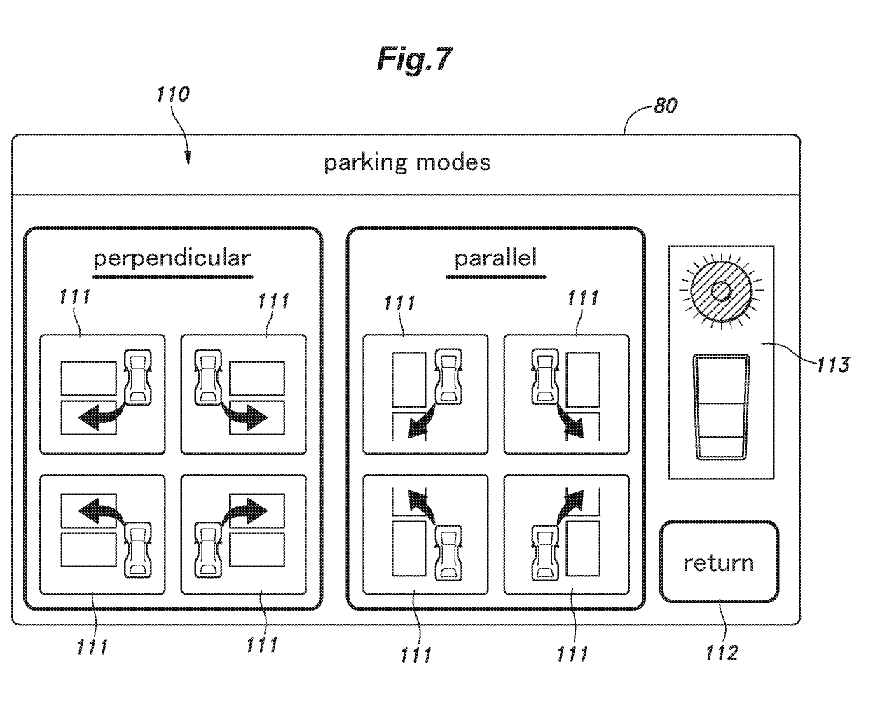

Once the automatic parking control is selected, a parking mode selection screen 110 is displayed in the automatic drive window 80 shown in FIG. 7. There are eight possible parking modes which are based on either parallel parking or perpendicular parking. The parking mode selection screen 110 shows eight icons 111 corresponding to the eight parking modes. Parallel parking and perpendicular parking each includes four different modes depending on the way the vehicle moves to a designated parking space. In the case of perpendicular parking shown on the left side of the automatic drive window 80, the vehicle 1 may move backward to a parking space on the left hand side or on the right hand side of the vehicle, or move forward to a parking space on the left hand side or on the right hand side of the vehicle. In the case of parallel parking shown to the right of the graphics showing the different modes of perpendicular parking, the vehicle may move backward to a parking space on the left hand side or on the right hand side of the vehicle, or move forward to a parking space on the left hand side or on the right hand side of the vehicle. The parking mode selection screen 110 additionally shows a return icon 112 in a lower right corner thereof for returning to the parking/unparking selection screen 100, and a guidance display 113 above the return icon 112. The vehicle operator selects one of the eight parking mode icons 111 corresponding to the desired parking mode by operating the direction button 46 of the selection switch 41, and pressing the determination button 47, thereby completing the selection of the parking mode.

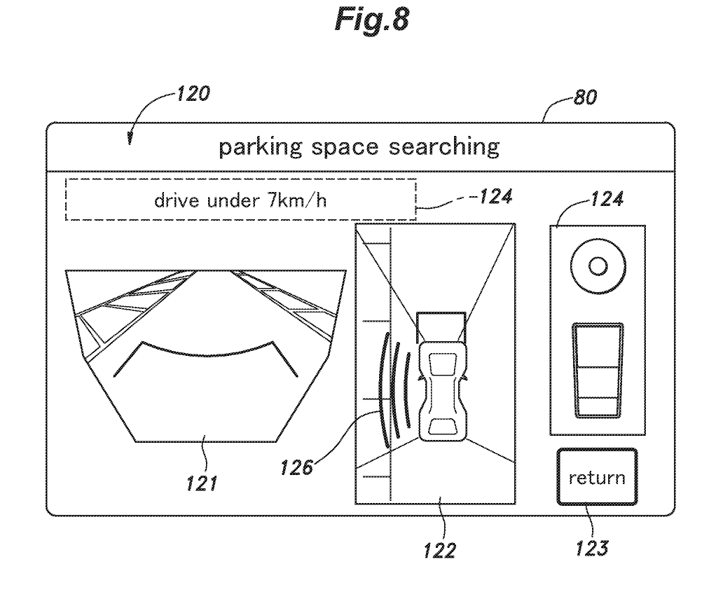

Once the parking mode is selected, the parking space search screen 120 is displayed in the automatic drive window 80 as shown in FIG. 8. In the parking space search screen 120, a camera image 121 is displayed on a left part, a ground view 122 is displayed in a central part while a return icon 123 for returning to the parking mode selection screen 110 is displayed in a lower right corner and a guidance display 124 is displayed above the return icon 123. The viewing direction of the camera image 121 is determined by the shift position. When the shift position is drive, the camera image 121 consists of the forward view from the vehicle 1. When the shift position is reverse, the camera image 121 consists of the rear view from the vehicle 1. The ground view 122 is a virtual image of the vehicle 1 as viewed from above or, in other words, is a plan view of the vehicle 1 and the surrounding area, and is created by combining images obtained by the front, back, right and left image capturing devices of the camera 11. The ground view includes a symbol 126 indicating a parking space search direction (right or left) associated with the selected parking mode. An instruction prompting the vehicle operator to drive at a low speed may be displayed in the guidance display 124.

Once the parking mode is selected, the vehicle operator drives the vehicle 1 to the vicinity of the parking space. At this time, the control device 10 searches a parking space based on the image acquired by the camera 11. Searching the parking space may be performed based on a white line surrounding the parking space or the size of the space between the vehicles that are already parked. Once a parking space is identified, and selected, the control device 10 detects if the vehicle 1 has reached an automatic drive start position (see (II) in FIG. 11). The automatic drive start position is a position from which the vehicle 1 can move into the selected parking space. For example, in the case of leftward or rightward parallel parking, the automatic drive start position is set as a position where the vehicle 1 has passed the front end of the parking space by a predetermined distance. The control device 10 detects if the vehicle 1 has reached the automatic drive start position based on the image acquired by the camera 11.

Once it is detected that the vehicle 1 has reached the automatic drive start position, the control device 10 prompts the vehicle operator by using the guidance display 124 of the parking space search screen 120 to change the shift position to neutral and to release the brake. In addition, the control device 10 may prompt the vehicle driver by synthesized speech to change the shift position to neutral, and release the brake.

When the vehicle operator has operated the shift switch 14 to neutral, the control device 10 displays on the guidance display 124 an instruction for prompting the vehicle operator to release the steering wheel 6, and to operate the automatic drive continuation switch 42. The control device 10 may display a graphic representing the switch unit 17 on the guidance display 124, and light up the part thereof corresponding to the automatic drive continuation switch 42.

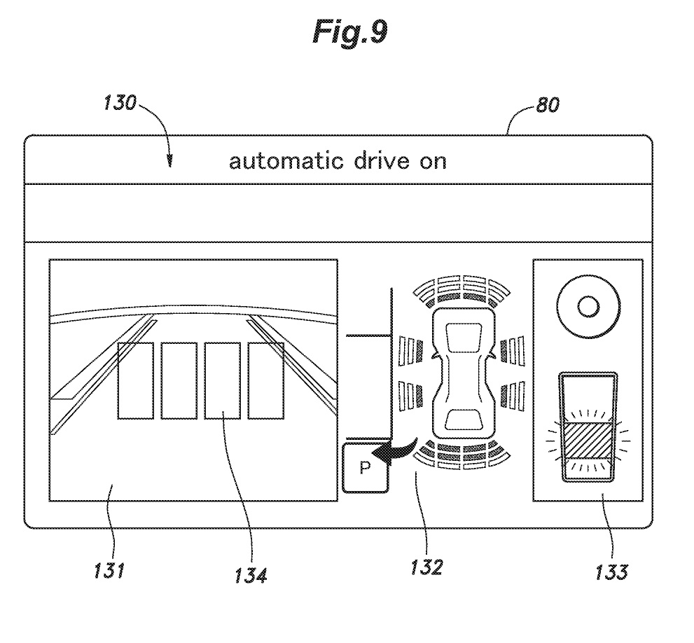

Once the vehicle operator has turned on the automatic drive continuation switch 42 by pulling the knob 49 of the automatic drive continuation switch 42, the control device 10 drives the traveling motor 4 and the steering motor 7 as required to automatically drive the vehicle 1. At the same time, an automatic drive screen 130 is displayed in the automatic drive window 80 as shown in FIG. 9. In the automatic drive screen 130, a camera image 131 is displayed on the left hand side and a sonar display 132 is displayed on the right hand side. The viewing direction of the camera image 131 that is displayed is selected according to the shift position selected by the control device 10. When the shift position is drive, an image ahead of the vehicle is displayed, and when the shift position is reverse, an image behind the vehicle is displayed. In short, an image around the vehicle corresponding to the traveling direction of the vehicle 1 is displayed on the automatic drive screen 130 of the display device 18. The sonar display 132 shows an image that indicates the manner in which the vehicle 1 and an object existing around the vehicle 1 approach each other based on a signal from the sonar 12. For example, a scale having a plurality of graduation marking may be displayed so that the distance between the own vehicle and the surrounding object may be indicated by lighting the corresponding graduation marking or lighting a corresponding length of the scale. A warning display 134 indicating the approach of an object existing around the vehicle 1 to the vehicle 1 is displayed in the central part of the camera image 131 based on the signal from the sonar 12. The warning display 134 may be, for example, a bar whose length and/or color change depending the distance to the approaching object.

While the automatic drive continuation switch 42 is turned on, the control device 10 drives the traveling motor 4 and the steering motor 7 as required to automatically drive the vehicle 1. When the vehicle operator turns off the automatic drive continuation switch 42, or the automatic drive continuation switch 42 is returned to the initial position, the control device 10 stops the automatic drive or the automatic control of the traveling motor 4 and the steering motor 7. In the automatic drive, the control device 10 computes the traveling path of the vehicle 1 based on the image information acquired by the camera 11, and computes the control amounts of the traveling motor 4 and the steering motor 7 on the basis of the computed traveling path, and controls the traveling motor 4 and the steering motor 7 accordingly. Even while the vehicle 1 is operating in automatic drive, the vehicle operator can adjust the traveling speed of the vehicle 1 by operating the brake.

The control device 10 is configured to detect if the vehicle 1 has reached a prescribed parking position in the selected parking space based on the image information acquired by the camera 11. Once the vehicle 1 has reached the prescribed parking position (see (III) in FIG. 11) in the parking space, the control device 10 deletes the camera image 131 on the automatic drive screen 130, and informs the vehicle operator that the parking has been completed by showing a message in the guidance display 133. At the same time, the vehicle operator is prompted to turn off the automatic drive continuation switch 42, and press the automatic drive on/off switch 43 by showing an appropriate message in the guidance display 133. The vehicle operator completes the automatic parking control by turning off the automatic drive continuation switch 42, pressing the automatic drive on/off switch 43, and activating the parking brake.

### Automatic Unparking Control

In initiating the automatic unparking control, the vehicle operator pushes the automatic drive on/off switch 43 while the vehicle 1 is stationary in the parking space (see (IV) in FIG. 11). This causes the control device 10 to start the automatic drive control, and the parking/unparking selection screen 100 to be displayed in the automatic drive window 80 in the center of the display device 18 as shown in FIG. 6. The vehicle operator then selects the desired automatic unparking icon 102 by operating the direction button 46 of the selection switch 41, and pressing the determination button 47, thereby completing the selection of the automatic unparking control.

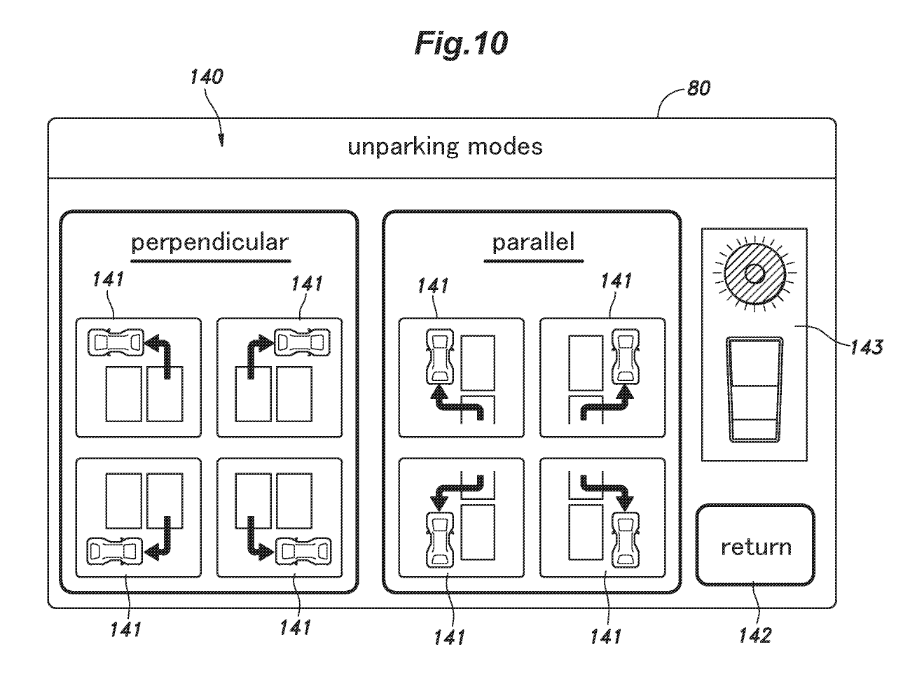

Once the selection of the automatic unparking control is completed, an unparking mode selection screen 140 shown in FIG. 10 is displayed in the automatic drive window 80. There are eight possible unparking modes which are based on either parallel unparking or perpendicular unparking. The unparking mode selection screen 140 shows eight icons 141 corresponding to the eight unparking modes. Parallel unparking and perpendicular unparking each includes four different modes depending on the way the vehicle moves out of a parking space. In the case of perpendicular unparking shown on the left side of the automatic drive window 80, the vehicle may move forward out of the parking space to the left or to the right, or move rearward out of the parking space to left or to the right. In the case of parallel parking shown to the right of the graphics showing the different modes of perpendicular unparking, the vehicle may move forward out of the parking space to the left or to the right, or move rearward out of the parking space to the left or to the right. The unparking mode selection screen 140 additionally shows a return icon 142 in a lower right corner thereof for returning to the parking/unparking selection screen 100, and a guidance display 143 above the return icon 142. The vehicle operator selects one of the eight unparking mode icons 141 corresponding to the desired unparking mode by operating the direction button 46 of the selection switch 41, and pressing the determination button 47, thereby completing the selection of the unparking mode.

Once the unparking mode is selected, the automatic drive screen 130 is displayed in the automatic drive window 80 as shown in FIG. 9. The control device 10 prompts the vehicle operator via the text message in the guidance display 133 of the automatic drive screen 130 to set the shift position to neutral, to release the brake pedal, to release the hands from the steering wheel 6, and to operate the automatic drive continuation switch 42. The control device 10 additionally displays the graphic representation of the switch unit 17 on the guidance display 133, and lights the graphic representation of the automatic drive continuation switch 42.

When the vehicle operator turns on the automatic drive continuation switch 42 by pulling up the automatic drive continuation switch 42, the control device 10 drives the traveling motor 4 and the steering motor 7 to automatically drive the vehicle 1. In this automatic drive, the control device 10 computes the traveling path of the vehicle 1 based on the image information acquired by the camera 11, and computes the control amounts of the traveling motor 4 and the steering motor 7 on the basis of the computed traveling path, and controls the traveling motor 4 and the steering motor 7 accordingly. Even while the vehicle 1 is operating in automatic drive, the vehicle operator can adjust the traveling speed of the vehicle 1 by operating the brake.

Based on the image acquired by the camera 11, the control device 10 determines if the vehicle 1 has reached a predetermined position (see (V) in FIG. 11) outside the parking space. When the vehicle 1 has reached the predetermined position outside the parking space, the control device 10 deletes the camera image 131 on the automatic drive screen 130, and informs the vehicle operator that the unparking has been completed by showing a message in the guidance display 133. At the same time, the vehicle operator is prompted to turn off the automatic drive continuation switch 42, and press the automatic drive on/off switch 43 by showing an appropriate message in the guidance display 133. The vehicle operator completes the automatic unparking control by turning off the automatic drive continuation switch 42, and pressing the automatic drive on/off switch 43.

In the vehicle 1 configured as described above, since the switch unit 17 that accepts the input operation for automatic drive is disposed on the side of the seat cushion 24 independently of or remote from other switches, the vehicle operator can comfortably identify the switch unit 17, and operate the switch unit 17. Since the vehicle operator can operate the switch unit 17 simply by lowering the hand (forearm) while seated in the vehicle operator's seat 21, the operation can be performed in a both effortless and comfortable manner. Furthermore, since the vehicle operator's hand is positioned away from the steering wheel 6 when operating the switch unit 17, contact with the steering wheel 6 can be avoided.

Since the automatic drive continuation switch 42 is provided with the inadvertent operation prevention feature, even when the vehicle operator inadvertently comes into contact with the automatic drive continuation switch 42, for example, when getting on and off the vehicle 1, an unintended operation of the automatic drive continuation switch 42 can be avoided. Since the automatic drive continuation switch 42 outputs a signal relating to control directly associated with the traveling of the vehicle 1, by providing the automatic drive continuation switch 42 with the inadvertent operation prevention feature, a high level of safety in controlling the traveling of the vehicle 1 can be achieved. Since the inadvertent operation prevention feature is formed by the use of the pull-up knob 49, changes in the switch state of the automatic drive continuation switch 42 due to accidental contact by an external object or a body part of the vehicle operator is effectively prevented. In addition, since the vehicle operator can operate the automatic drive continuation switch 42 simply by lifting the pull-up knob 49, the automatic drive continuation switch 42 can be operated in an effortless manner. In addition, since the automatic drive continuation switch 42 is a momentary switch, and enables the automatic drive of the vehicle 1 only while being operated, it is possible that the passenger can quickly interrupt the automatic drive control when it is desired to stop the automatic drive control of the vehicle 1.

Since the operation surface 36 of the switch unit 17 is disposed below the seat surface 44 of the seat cushion 24, the vehicle operator is prevented from unintentionally contacting the switch unit 17 when getting on and off the vehicle 1. Furthermore, since the automatic drive continuation switch 42 is disposed rearwardly of the center of the seat cushion 24 in the fore and aft direction, it is unlikely for the vehicle operator to contact the automatic drive continuation switch 42 when getting on and off the vehicle 1.

The switch unit 17 contains all of the input means that are required for the automatic drive control such as the selection switch 41, the automatic drive on/off switch 43, and the automatic drive continuation switch 42 so that the vehicle operator can enter all the inputs that are required for the automatic drive control from the switch unit 17, the automatic drive control can be performed in a comfortable and reliable manner.

The selection switch 41 and the automatic drive on/off switch 43 for producing signals that do not directly cause a change in the driving condition of the vehicle 1 consist of simple push buttons. This contributes to a comfortable operation for automatic drive control.

Although the present invention has been described in terms of a specific embodiment, the present invention is not limited by the embodiment, but various parts thereof can be substituted and modified without departing from the spirit of the present invention. For example, the inadvertent operation prevention feature of the automatic drive continuation switch 42 may also be a cover covering the knob 49. In this case, since the knob 49 can be operated only when the cover is opened, the automatic drive continuation switch 42 is prevented from being inadvertently or unintentionally operated even when the automatic drive continuation switch 42 consists of a push switch (push return).

Further, in an alternate embodiment, the switch unit 17 is provided on a door on a side of the vehicle operator's seat 21. The switch unit 17 may be provided in the door lining separately from the power window switch.

Further, in addition to the switch unit 17 and the display device 18, the automatic drive operation device 13 may be further provided with an operation terminal 150 for accepting an input operation for automatic drive of the vehicle 1 by the vehicle operator which is configured to be taken out of the vehicle 1 or transported from the vehicle 1 as shown in FIG. 1. The operation terminal 150 is provided with a display unit 151 for displaying options that can be selected for automatic drive, and an operation input unit 152 incorporated with switches corresponding to the selection switch 41, the automatic drive continuation switch 42, and the automatic drive on/off switch 43. The operation terminal 150 may be configured as a touch panel integrating the display unit 151 and the operation input unit 152. Further, the operation terminal 150 may consist of a smartphone or a tablet PC operating under a prescribed app. The operation terminal 150 communicates with the control device 10 and transmits a signal for the operation input received by the operation input unit 152 to the control device 10, and receives an image from the control device 10 and changes the image to be displayed on the display unit 151 as required. The display unit 151 may display an image in a similar manner as the display device 18. For example, similarly to the display device 18, the image around the vehicle corresponding to the traveling direction of the vehicle 1 may be displayed on the display unit 151. The vehicle operator can automatically drive the vehicle 1 from outside of the vehicle 1 by using the operation terminal 150.

1. A vehicle operation device for enabling a vehicle operator to operate a vehicle, comprising:
a switch unit provided at a side of a vehicle operator's seat, and configured to accept an input operation for automatic drive of the vehicle.

2. The vehicle operation device as defined in claim 1, wherein the switch unit is positioned next to a side of a seat cushion of the vehicle operator's seat.

3. The vehicle operation device as defined in claim 2, wherein the switch unit includes a first switch provided with an inadvertent operation prevention feature configured to prevent an unintended contact to the first switch.

4. The vehicle operation device as defined in claim 3, wherein the first switch is configured to produce a signal relating to a control action for vehicle travel.

5. The vehicle operation device as defined in claim 4, wherein the first switch comprises a momentary switch that enables automatic drive of the vehicle only while being operated.

6. The vehicle operation device as defined in claim 5, wherein the first switch comprises a knob that turns on the first switch when pulled up as the inadvertent operation prevention feature.

7. The vehicle operation device as defined in claim 6, wherein the first switch is disposed rearward of a center of the seat cushion with respect to a fore and aft direction.

8. The vehicle operation device as defined in claim 2, wherein the switch unit is disposed adjacent to a side of the seat cushion facing a door opening.

9. The vehicle operation device as defined in claim 8, wherein the switch unit is positioned on a floor of the vehicle.

10. The vehicle operation device as defined in claim 2, wherein an operation surface of the switch unit is disposed below a seating surface of the seat cushion.

11. The vehicle operation device as defined in claim 1, wherein the switch unit includes a second switch consisting of a push button switch configured to produce a signal not relating to a control action for vehicle travel.

12. The vehicle operation device as defined in claim 1, wherein the switch unit is configured to produce a signal for controlling automatic parking of the vehicle.

13. The vehicle operation device as defined in claim 1, wherein the switch unit is incorporated with an entirety of input devices for controlling automatic drive of the vehicle.

14. The vehicle operation device as defined in claim 1, further comprising a display device disposed in front of the vehicle operator's seat of the vehicle to display options relating to automatic drive of the vehicle that can be selected by operation of the switch unit.

15. The vehicle operation device as defined in claim 14, wherein the display device is configured to display information on an environment surrounding the vehicle associated with a traveling direction of the vehicle.

16. The vehicle operation device as defined in claim 14, wherein the display device is configured to display information on an environment surrounding the vehicle in response to an operation of the switch unit.

17. The vehicle operation device as defined in claim 1, further comprising an operation terminal that can be transported from the vehicle, and is configured to accept an input operation by the vehicle operator for automatic drive of the vehicle.

18. The vehicle operation device as defined in claim 17, wherein the operation terminal includes a display unit configured to display information on an environment surrounding the vehicle associated with a traveling direction of the vehicle.

19. The vehicle operation device as defined in claim 17, wherein the operation terminal includes a display unit configured to display options relating to automatic drive of the vehicle that can be selected by operation of the operation terminal.
